(19) United States
(12) Patent Application Publication
(10) Pub. No.: US 2017/0171710 A1
(43) Pub. Date: Jun. 15, 2017

(54) LINKAGE OF GEOLOCATION AND TIME WITH MOBILE CONNECTION SERVICE MANAGEMENT

(71) Applicant: INTERNATIONAL BUSINESS MACHINES CORPORATION, Armonk, NY (US)

(72) Inventor: Douglas S. Rothert, Austin, TX (US)

(21) Appl. No.: 14/969,980

(22) Filed: Dec. 15, 2015

(51) Int. Cl. H04W 4/02; H04W 4/00

(52) U.S. Cl. CPC H04W 4/023; H04W 4/021; H04W 4/008; H04W 84/12

(57) ABSTRACT

A method, system and computer program product for managing a connection service at a mobile device is disclosed. A location of the mobile device is detected. A location of a communication node that communicates with the mobile device using the connection service is obtained. The connection service is turned off at the mobile device when a distance between the location of the mobile device and the location of the communication node is greater than a selected distance threshold.

### BACKGROUND

The present invention relates generally to communication connection services for mobile communication devices and, more specifically, to managing the linking of communication connection services based on a geolocation of the mobile device or according to a schedule.

Many mobile technologies, such as mobile communication devices, include connection services, such as WiFi or Bluetooth for short range communication. Users often will turn on these connection services when within range of a communication node of a device that operates using the selected communication technology. Once out of range of the communication node however, the user often forgets to turn off the connection service. Leaving the connection service turned on while out of range of the communication node not only wastes power at the mobile device but also unintentionally exposes the cellular device to security intrusions, such as virus attacks, hacking, etc.

### SUMMARY

Embodiments include a method, system and computer program product for managing a connection service at a mobile device. The method includes: detecting a location of the mobile device; obtaining a location of a communication node that communicates with the mobile device using the connection service; and turning off the connection service at the mobile device when a distance between the location of the mobile device and the location of the communication node is greater than a selected distance threshold.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 schematically illustrates a mobile device in accordance with one embodiment of the present invention;

FIG. 2 illustrates operation of the mobile device in accordance with one embodiment of the present invention;

FIG. 3 illustrates a mobile device outside of a range of service of a communication node, in accordance with one embodiment of the present invention;

FIG. 4 illustrates operation of the mobile device with respect to a vehicle according to one embodiment of the present invention;

FIG. 5 shows a schedule for managing a connection service using a connection service management program, according to another embodiment of the present invention;

FIG. 6 illustrates a block diagram of a computer system for use in implementing a system or method according to some embodiments and

FIG. 7 shows a flowchart of a method for managing connection services at a mobile device according to an embodiment of the present invention.

### DETAILED DESCRIPTION

Embodiments of the present invention include a system, method and computer program product for managing communication connection services at a mobile communication device in order to conserve energy and reduce security risks at the mobile communication device. Communication connection services for the mobile device can be coordinated with a specific schedule or with a Global Positioning Satellite (GPS) location of the mobile device. In particular, the communication connection service can be turned on or off based on its proximity to or distance from a communication node that operates using the selected connection service.

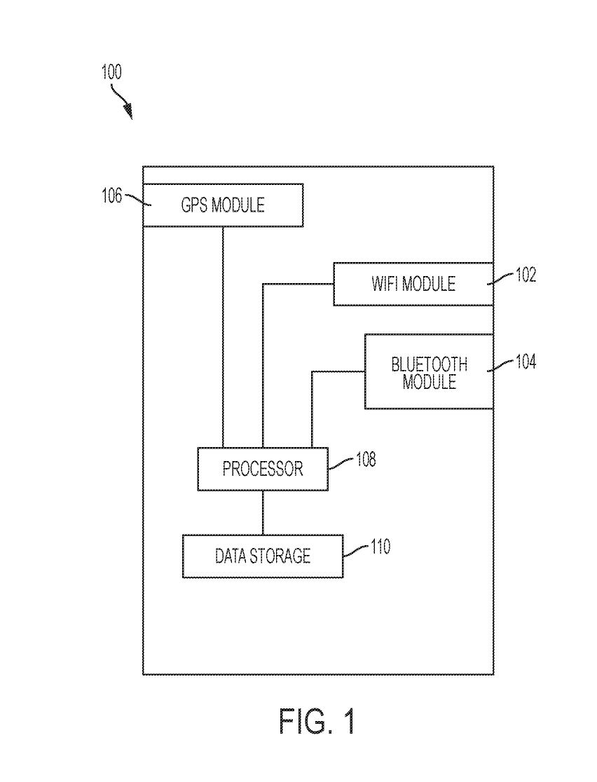

FIG. 1 schematically illustrates a mobile device 100 in accordance with one embodiment of the present invention. The mobile device 100 includes various communication modules that provide multiple channels of communication for the mobile device 100. For example, the mobile device 100 includes a WiFi module 102 that provides a WiFi connection service to a remote node such as a WiFi router, and a Bluetooth module 104 that provides a connection service for Bluetooth. A GPS module 106 allows the mobile device to receive a GPS signal indicating the GPS location of the mobile device 100. The mobile device 100 further includes a processor 108 and data storage device 110, such as a solid-state or non-transitory solid device. The data storage device 110 can store GPS location data and the processor 108 can store data to the data storage device 110 and read data from the data storage device 110. In one embodiment, the processor 108 controls various functions of the mobile device 100 and its various modules. For example, the processor 108 can calculate distances between the mobile device 100 and selected locations, such as location of communication nodes for the WiFi or Bluetooth communications. The processor 108 can turn on and off the selected connection service based on the calculated distances. Additionally, the processor 108 can run a connection service management program to turn on and off a selected connection service based on time of day.

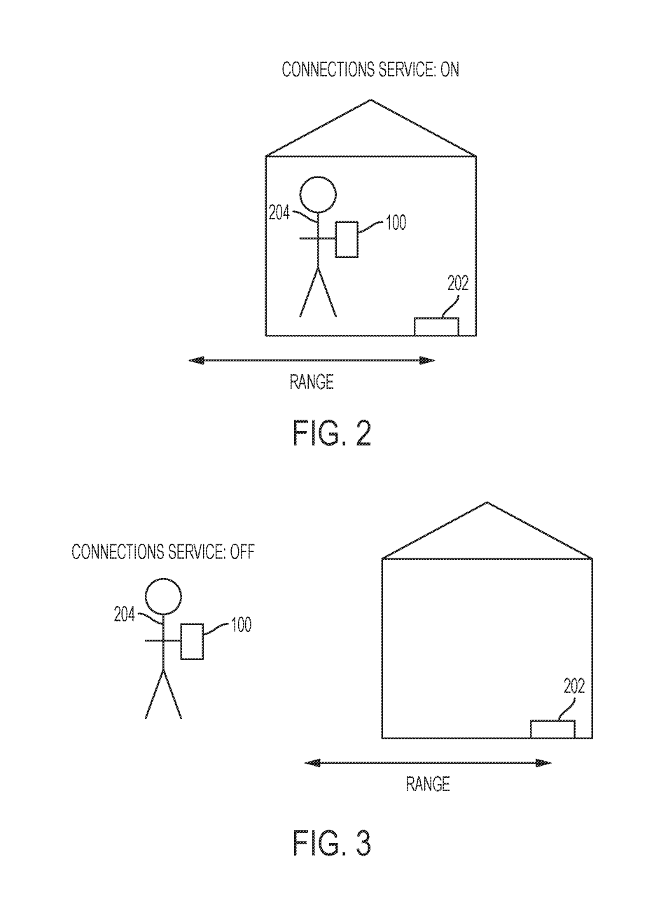

FIG. 2 illustrates operation of the mobile device 100 in accordance with one embodiment of the present invention. The mobile device 100 is in communication with a short range communication node 202, such as a WiFi node, Bluetooth device, etc. When the mobile device 100 is within range of the communication node 202, the user 204 can turn on the corresponding connection service. The mobile device 100 will then connect to the nearby communication node 202. The mobile device 100 can then obtain a location of the communication node 202, generally a GPS location of the communication node 202. In one embodiment, the communication node 202 can transmit its GPS location to the mobile device 100. The GPS location of the mobile device 100 can be tracked over time and the mobile device 100.

FIG. 3 illustrates a mobile device 100 outside of a range of service of a communication node 202, in accordance with one embodiment of the present invention. The processor 108 of the mobile device 100 calculates a distance between the mobile device 100 and the communication node 202 use the GPS location of the mobile device 100 and the stored GPS location of the communication node 202. The processor 108 turns off the connection service when the calculated distance is greater than a selected distance threshold. The selected distance threshold can be a standard range of service of the communication node 202. In another embodiment, the processor 108 turns off the connection service when the distance is greater than the selected distance threshold for an amount of time that exceeds a selected time duration, for example, 30 seconds. The processor 108 can keep tracking the distance between the mobile device 100 and the communication node 202 after the connection service has been turned off. When the calculated distance becomes less than the selected distance threshold (i.e., when the user returns to within range of the communication node 202), the mobile device 100 can turn on the relevant connection service so as to communicate with the communication node 202.

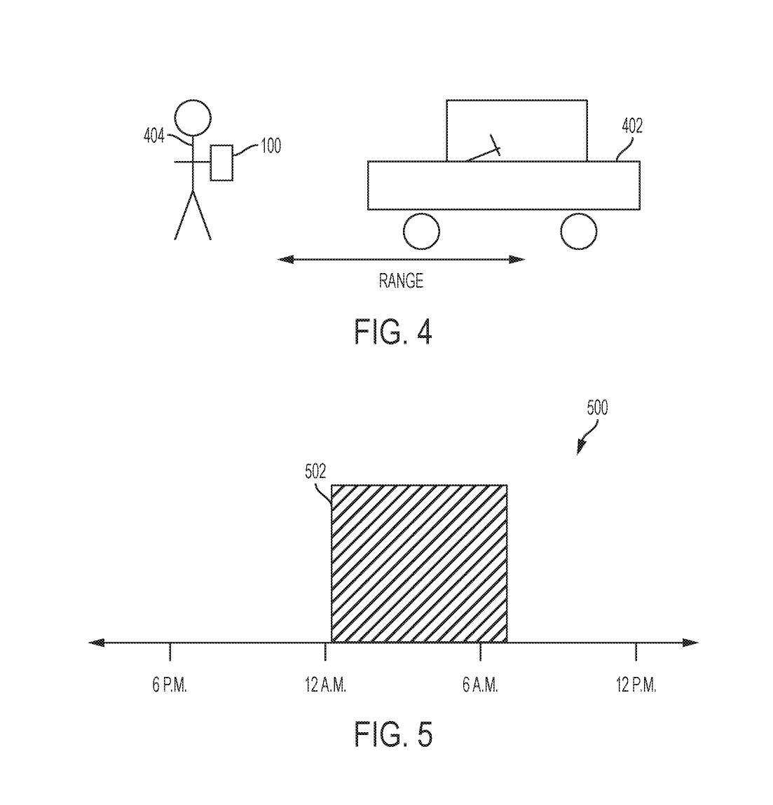

FIG. 4 illustrates operation of the mobile device 100 with respect to a vehicle 402 according to one embodiment of the present invention. Mobile device 100 can establish a Bluetooth connection with the vehicle 402 when the user 404 is inside the vehicle 402, either as a driver or as a passenger. When the user 404 leaves the vehicle 402 or when the vehicle 402 is turned off, the vehicle 402 can transmit its current GPS location to the mobile device 100, which stores the GPS location of the vehicle 402. Alternatively, the mobile device 100 can determine based on a relative speed of the mobile device 100, that the user 404 is walking rather than driving and can then determine the GPS location at which the vehicle 402 is parked from a transition between driving and walking and store that GPS location as the location the vehicle 402.

The processor 108 of the mobile device 100 calculates a distance between the mobile device 100 and the vehicle 402 and turns off the Bluetooth service either when the distance is greater than a selected distance threshold or when the distance is greater than the selected distance threshold for a selected time duration. As the user 404 walks around, the processor 108 tracks the distance between mobile device 100 and vehicle 402 and when the user 404 returns to the vehicle 402, the mobile device 100 turns on the connection service so as to re-establish the Bluetooth connection service with the vehicle 402.

FIG. 5 shows a schedule 500 for managing a connection service using a connection service management program, according to another embodiment of the present invention. The power state of the connection service can be controlled according to a schedule. For example, the connection service can be turned off at times of little use or of no use, such as when the user is asleep. The illustrative schedule 500 shows a block of time (502) from 12 midnight to about 7:00 a.m. during which the connection service is to be turned off. Such time management of the connection service reduces energy use at the mobile device 100 and also reduces security risks.

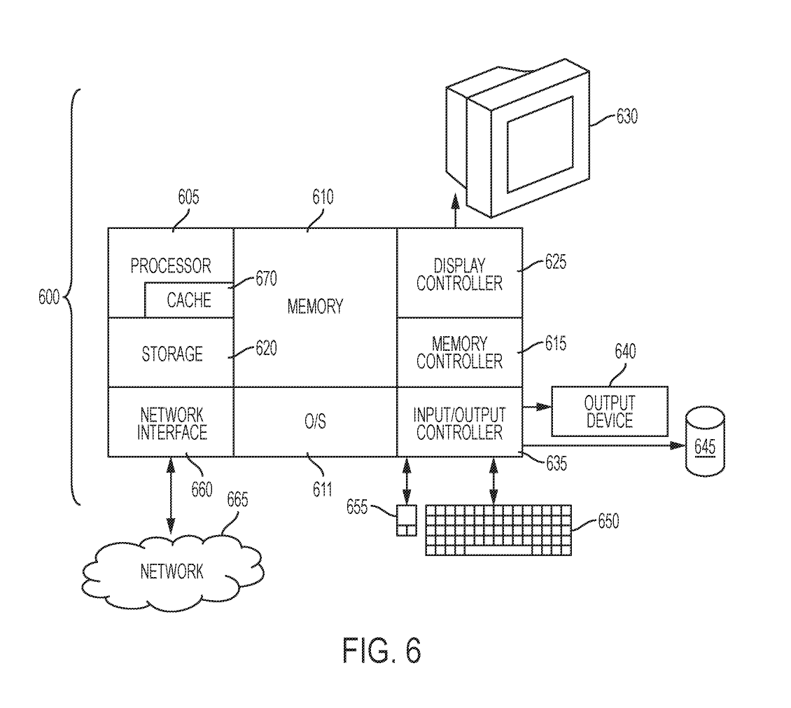

FIG. 6 illustrates a block diagram of a computer system 600 for use in implementing a system or method according to some embodiments. The systems and methods described herein may be implemented in hardware, software (e.g., firmware), or a combination thereof. In some embodiments, the methods described may be implemented, at least in part, in hardware and may be part of the microprocessor of a special or general-purpose computer system 600, such as a personal computer, workstation, minicomputer, or mainframe computer.

In some embodiments, as shown in FIG. 6, the computer system 600 includes a processor 605, memory 610 coupled to a memory controller 615, and one or more input devices 645 and/or output devices 640, such as peripherals, that are communicatively coupled via a local I/O controller 635. These devices 640 and 645 may include, for example, a printer, a scanner, a microphone, and the like. Input devices such as a conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 640, 645 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 610. The processor 605 may be a custom made or commercially available processor, a central processing unit (CPU), an auxiliary processor among several processors associated with the computer system 600, a semiconductor based microprocessor (in the form of a microchip or chip set), a macroprocessor, or other device for executing instructions. The processor 605 includes a cache 670, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 670 may be organized as a hierarchy of more cache levels (L1, L2, etc.).

The memory 610 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, or other types of storage media. Note that the memory 610 may have a distributed architecture, where various components are situated remote from one another but may be accessed by the processor 605.

The instructions in memory 610 may include one or more separate programs, each of which comprises an ordered listing of executable instructions for implementing logical functions. In the example of FIG. 6, the instructions in the memory 610 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 620, which may be a storage device such as a hard disk drive or solid state drive. The stored instructions in memory 610 or in storage 620 may include those enabling the processor to execute one or more aspects of the systems and methods of this disclosure.

The computer system 600 may further include a display controller 625 coupled to a display 630. In some embodiments, the computer system 600 may further include a network interface 660 for coupling to a network 665. The network 665 may be an IP-based network for communication between the computer system 600 and an external server, client and the like via a broadband connection. The network 665 transmits and receives data between the computer system 600 and external systems. In some embodiments, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in computer systems 600, such as that illustrated in FIG. 6.

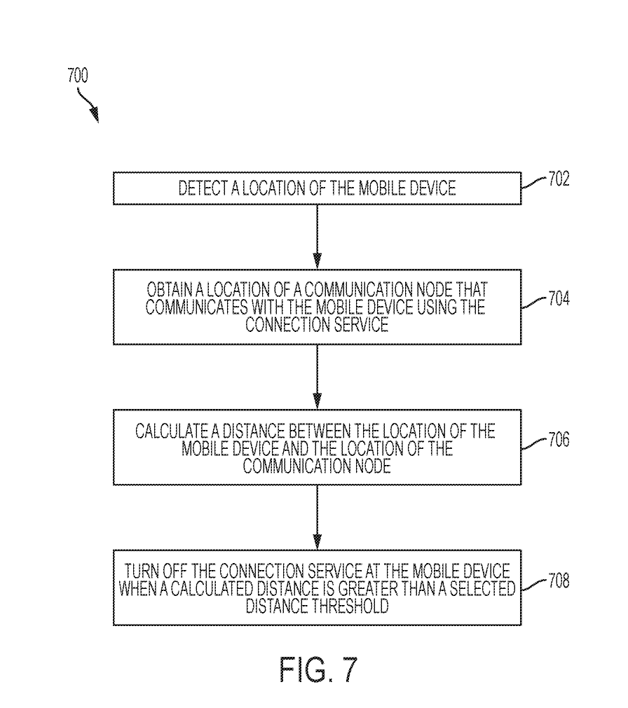

FIG. 7 shows a flowchart 700 of a method for managing connection services at a mobile device according to an embodiment of the present invention. In Box 702, a location of the mobile device (generally, but not necessarily, a GPS location) is detected at the mobile device. In Box 704, the mobile device obtains a location of a communication node that communicates with the mobile device using the connection service. In Box 706, the mobile device calculates a distance between the location of the mobile device and the location of the communication node. In Box 708, the mobile device turns off the connection service when the calculated distance is greater than a selected distance threshold.

Technical effects and benefits of some embodiments include reducing a vulnerability of the mobile device to security risks such as virus, hackers, electronic snooping, etc. Also, the embodiments provide a method of conserving energy at the mobile device by turning off connection services that are out of range of their communication nodes and which are therefore not usable.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing a connection service at a mobile device, the method comprising:
detecting, at the mobile device, a location of the mobile device;
obtaining, at a communication node, a location of the communication node that communicates with the mobile device using the connection service, wherein the communication node is a component of a vehicle;
receiving, at the mobile device and from the communication node, the location of the communication node at which the vehicle is parked when the mobile device undergoes a transition from a driving speed to a walking speed; and
turning off the connection service at the mobile device when a distance between the location of the mobile device and the location of the communication node is greater than a selected distance threshold.

2. The method of claim 1, further comprising turning off the connection service when the distance is greater than the selected distance threshold for a selected time duration.

3. The method of claim 1, further comprising turning on the connection service when the distance is less than the selected distance threshold.

4. The method of claim 1, further comprising storing the location of the communication node at the mobile device.

5. (canceled)

6. The method of claim 1, further comprising managing a power state of the connection service according to a schedule.

7. The method of claim 1, wherein the location is a Global Positioning Satellite (GPS) location.

8. A system for managing a connection service of a mobile device, the system comprising:
a memory having computer readable instructions therein; and
one or more processors accessible to the memory, wherein the computer readable instructions when read by the one or more processor causes the one or more processors to perform a method, the method comprising:
detecting a location of the mobile device;
receiving at the mobile device a location of a communication node that communicates with the mobile device using the connection service, wherein the communication node is a component of a vehicle and the location is a location at which the vehicle is parked when the mobile device leaves the vehicle; and
turning off the connection service at the mobile device when a distance between the location of the mobile device and the location of the communication node is greater than a selected distance threshold.

9. The system of claim 8, wherein the computer readable instructions further comprise turning off the connection service when the distance is greater than the selected distance threshold for a selected time duration.

10. The system of claim 8, wherein the computer readable instructions further comprises turning on the connection service when the distance is less than the selected distance threshold.

11. The system of claim 8, wherein the computer readable instructions further comprise storing the location of the communication node at the mobile device.

12. (canceled)

13. The system of claim 8, wherein the computer readable instructions further comprise managing a power state of the connection service according to a schedule.

14. The system of claim 8, wherein the location is a Global Positioning Satellite (GPS) location.

15. A non-transitory computer program product for managing a connection service of a mobile device, the computer program product comprising a computer readable storage medium having program instructions embodied therewith, the program instructions executable by a processor to cause the processor to perform:
detecting a location of the mobile device;
obtaining, from a communication node, a location of the communication node that communicates with the mobile device using the connection service, wherein the communication node is a component of a vehicle and the location is a location at which the vehicle is parked when the mobile device leaves the vehicle; and
turning off the connection service at the mobile device when a distance between the location of the mobile device and the location of the communication node is greater than a selected distance threshold.

16. The non-transitory computer program product of claim 15, wherein the method further comprises turning off the connection service when the distance is greater than the selected distance threshold for a selected time duration.

17. The non-transitory computer program product of claim 15, wherein the method further comprises turning on the connection service when the distance is less than the selected distance threshold.

18. The non-transitory computer program product of claim 15, wherein the method further comprises storing the location of the communication node at the mobile device.

19. The non-transitory computer program product of claim 15, wherein the method further comprises managing a power state of the connection service according to a schedule.

20. The non-transitory computer program product of claim 15, wherein the location is a Global Positioning Satellite (GPS) location.
